(19) United States
(12) Patent Application Publication
(10) Pub. No.: US 2007/0007280 A1
(43) Pub. Date: Jan. 11, 2007

(54) Method for producing a circuit module

(76) Inventor: Reinhold Bayerer, Warstein (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/482,663

(22) Filed: Jul. 7, 2006

(30) Foreign Application Priority Data
Jul. 8, 2005 (DE) 10 2005 032 076.7

(51) Int. Cl. B23K 13/01

(52) U.S. Cl. 219/604

(57) ABSTRACT

A method for producing a circuit module is disclosed. In one embodiment, when attaching a semiconductor substrate by an underside on an upper side of a carrier by adhesion, a curing temperature is chosen and set in such a way that the underside of the semiconductor substrate corresponds in its shape completely or substantially in a conformal manner to the upper side of the carrier.

### CROSS-REFERENCE TO RELATED APPLICATIONS

This Utility Patent Application claims priority to German Patent Application No. DE 10 2005 032 076.7 filed on Jul. 8, 2005, which is incorporated herein by reference.

### FIELD OF THE INVENTION

The invention relates to a method for producing a circuit module. The invention relates in particular to an adhesive method for power semiconductor substrates on heat sinks.

### BACKGROUND

Apart from possible miniaturization and the improvement of functional reliability, simplifications in the area of the methods of production play an important part in the further development of modern power semiconductor electronics, while possible simplifications are not to be obtained at the expense of quality.

Previously, in the case of known methods of production, semiconductor modules have been produced on carriers in such a way that the finished semiconductor substrates are soldered or screwed on the surface of the carrier respectively to be provided. These methods of attachment and the corresponding mechanisms are in fact comparatively reliable and, if necessary, allow mechanically, thermally and electrically good contacting of the respective semiconductor substrates on a provided carrier. However, the corresponding methods of attachment and the associated mechanisms are comparatively difficult to provide, particularly requiring considerable extra expenditure on material and equipment even if they are part of an automation process.

For these and other reasons, there is a need for the present invention.

### SUMMARY

The present invention provides a method for producing a circuit module. In one embodiment, when attaching a semiconductor substrate by an underside on an upper side of a carrier by adhesion, a curing temperature is chosen and set in such a way that the underside of the semiconductor substrate corresponds in its shape completely or substantially in a conformal manner to the upper side of the carrier.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic and sectioned side view, which explains the basic structure of a circuit module.

FIG. 2 explains the basic structure of a circuit module likewise in the form of a schematic sectioned side view in a more detailed form.

FIGS. 3A-3C illustrate in a sequence of schematic and sectioned side views the procedure according to a first embodiment of the method according to the invention for producing a circuit module.

FIGS. 4A-4B illustrate, likewise in a sequence of schematic and sectioned side views, the procedure according to another embodiment of the method according to the invention for producing a circuit module.

FIGS. 5A-5C illustrate, likewise in a sequence of schematic and sectioned side views, the procedure according to another embodiment of the method according to the invention for producing a circuit module.

FIG. 6 illustrates in a perspective side view a circuit module which has been formed according to an embodiment of the method according to the invention for producing a circuit module.

FIG. 7 illustrates in a schematic and sectioned side view another structure of a circuit module which has been formed according to another embodiment of the method according to the invention for producing a circuit module.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention provides a method for producing semiconductor circuit modules in which semiconductor substrates can be attached in a particularly simple and nevertheless reliable way on carriers to be provided.

In one embodiment of the present invention in its most general context forms an adhesive bond instead of a soldered connection or a screwed connection between a semiconductor substrate and a carrier to be provided. Since, specifically in the area of power semiconductor electronics, adhesive bonds in the region of the power components have previously been avoided, it is now possible according to the invention to resort to this simple technique without losses in functional or structural quality occurring. Accordingly, the prejudice that has long existed among those skilled in the art is overcome according to the invention, in that the previously avoided adhesive technique is used according to the invention in an advantageous way for applying, fixing and contacting semiconductor substrates on carriers.

The known prejudice from the prior art is overcome by the adhesive between the semiconductor substrate and the carrier being cured, at least the semiconductor substrate being brought to and kept at a curing temperature during the curing, the curing temperature being chosen, set and/or maintained in such a way that the underside of the semiconductor substrate or the substrate corresponds completely or substantially in a conformal manner to the surface of the carrier. It is thereby achieved according to the invention that the surface or the upper side of the carrier and the underside of the substrate or semiconductor substrate are adapted to each other in a suitable way with regard to their surface geometry or topography, so that, with respect to the adhesive to be provided in between, after the curing process the desired shaping is preserved and mechanical stresses in the contact region or region of the boundary surface between the semiconductor substrate and the carrier, and in particular in the region of the semiconductor substrate itself, can be reduced or avoided entirely.

According to one embodiment of the invention, a method for producing a circuit module is provided, with the process of providing at least one semiconductor substrate having a semiconductor circuit on a substrate with an underside, providing at least one carrier having an upper side or surface and attaching and fixing the semiconductor substrate by the underside of the substrate or the semiconductor substrate on the upper side or surface of the carrier by adhesion using an adhesive, in which, during the adhesion, the adhesive is cured, in which at least the semiconductor substrate is brought to and kept at a curing temperature during the curing and in which the curing temperature is chosen and set in such a way that the underside of the substrate or the semiconductor substrate corresponds completely or substantially in a conformal manner to the upper side or surface of the carrier.

In one embodiment of the method according to the invention for producing a semiconductor module, it is provided that, with a planar or approximately planar upper side or surface of the carrier, the curing temperature is set and maintained in such a way that the underside of the substrate is planar or approximately planar.

In another embodiment of the method according to the invention for producing a semiconductor module, it is alternatively or additionally provided that the curing temperature is set and maintained in such a way that thermal stresses on account of different thermal expansion properties in the semiconductor substrate form and, in particular, compensate one another to create a desired shape of the underside of the substrate.

In another embodiment of a method according to the invention for producing a semiconductor module, it is alternatively or additionally provided that a substrate from the group formed by substrates with a number of different materials, substrates of a layered construction, DCB substrates, AMB substrates and ceramic-based substrates with metallic regions or components is used as the substrate or as the semiconductor substrate.

In another embodiment of the method according to the invention for producing a semiconductor module, it is alternatively or additionally provided that the curing temperature is set and maintained by heating the substrate, the semiconductor substrate and/or the adhesive.

On the other hand, in another embodiment of the method according to the invention for producing a semiconductor module, it is alternatively provided that the curing temperature is set and maintained by cooling the substrate, the semiconductor substrate and/or the adhesive.

In another embodiment of a method according to the invention for producing a semiconductor module in which, alternatively or additionally, at least the semiconductor substrate, and also the carrier and/or the adhesive, are kept constantly or approximately constantly at the curing temperature during the curing of the adhesive and, as a result, the layer thickness of the adhesive between the semiconductor substrate and the carrier is kept constant over time or approximately constant over time, in particular with the same or approximately the same layer thickness.

In another embodiment of the method according to the invention for producing a semiconductor module, it is alternatively or additionally provided that the semiconductor substrate, the carrier and/or the adhesive are jointly brought to the curing temperature and kept there, in particular by means of a heat bath.

According to another embodiment of a method according to the invention for producing a semiconductor module, it is alternatively or additionally provided that the semiconductor substrate and/or the adhesive are brought to the curing temperature and/or kept there, in that they are directly or indirectly thermally coupled with the carrier and in that the carrier is brought to the curing temperature and kept there, in particular by means of a heat bath.

In another embodiment of a method according to the invention for producing a semiconductor module, it is alternatively or additionally provided that a semiconductor substrate and/or an adhesive with a low thermal capacity in comparison with the carrier are used. A low thermal capacity is obtained, for example, if the product RC of the thermal resistance R of the adhesive, by means of which the substrate is thermally made to match the carrier, and the thermal capacity C of the substrate produces a value less than 5 seconds. The thermal capacity is, for example, also referred to as low if it is low as compared to the thermal capacity of the carrier.

In another embodiment of a method according to the invention for producing a semiconductor module, it is provided that an adhesive with a comparatively high thermal conductivity is used. A high thermal conductivity is obtained in particular whenever it has, for example, a value of more than 0.5 W/mK and furthermore of more than 5 W/mK.

According to another embodiment of a method according to the invention for producing a semiconductor module, it is provided that the semiconductor substrate, the carrier and/or the adhesive are brought to the curing temperature and kept there before the adhesive is applied to the underside of the substrate or the semiconductor substrate and/or to the upper side of the carrier.

Particular advantages are obtained if, according to another embodiment of the method according to the invention for producing a semiconductor module, it is provided that the semiconductor substrate and the carrier with the adhesive in between are brought against one another by application of pressure and fixed, so that the semiconductor substrate is thereby pressed into the adhesive.

According to another embodiment of a method according to the invention for producing a semiconductor module, the adhesive on the underside of the substrate or the semiconductor substrate and/or on the upper side of the carrier is applied such that it is planar or conformal or in certain portions is planar or conformal.

It is possible for the adhesive to be applied by screen printing, dispensing or stamping. Methods by means of vibrational movements, which accomplish horizontal and/or vertical rubbing in, are also conceivable.

In another embodiment of a method according to the invention for producing a semiconductor module, it is alternatively or additionally provided that the semiconductor substrate is first brought to a preliminary temperature, at which the underside of the substrate or the semiconductor substrate is formed convexly or locally convexly in relation to the upper side of the carrier, then the semiconductor substrate is applied by the underside of the substrate or the semiconductor substrate to the upper side of the carrier with the adhesive in between, and then the curing temperature is set and maintained.

In this case, it may be provided that the semiconductor substrate is pressed against the carrier or rolled out on it by pressure from the inside outward with respect to the contact area.

It is alternatively or additionally possible that an adhesive is used from the group including thermally conducting adhesives, filled silicone adhesives, epoxy resin adhesives, thermoplastic adhesives, polyester adhesives, adhesives in paste form, liquid adhesives, adhesives in the form of films, adhesives with a thermal conduction in the range of at least 0.5 W/mK, adhesives with a thermal conductivity in the range of more than 5 W/mK and adhesives which become liquid under temperature and/or pressure and solidify when a pressure is removed or they are relieved of stress.

On the other hand, it is alternatively or additionally conceivable to use carriers from the group including heat sinks, carrier plates, base plates, carriers of aluminum, carriers of AlSiC, MMC carriers, metal-matrix composite carriers, carriers of copper, nickel-plated carriers, liquid-cooled carriers or heat sinks, gas-cooled carriers or heat sinks and three-dimensionally shaped bodies.

Furthermore, it is alternatively or additionally possible to use semiconductor substrates from the group including power semiconductor substrates, signal-electronics semiconductor substrates and semiconductor substrates based on thin-film or thick-film ceramics.

It is particularly advantageously suitable for a number of semiconductor substrates to be attached on one or more portions of the surface of one or more carriers.

An adhesive with a layer thickness of below 70 μm is used with preference.

These and further embodiments of the present invention are explained with other words below.

In power semiconductor modules, usually power semiconductors are soldered on so-called DCB or AMB substrates (DCB: Direct Copper Bonded; AMB: Active Metal Brazed). The substrates are in turn soldered on base plates. The substrates are coated with thick copper or aluminum. The connection of the metal layers to the ceramic takes place by the specified connecting methods. The encapsulated modules are then generally screwed onto heat sinks. If it is wished to combine power semiconductor circuits with low-level signal electronics in one module, to simplify the process, it is attractive to adhesively attach the circuit carriers with the power semiconductors, that is for example DCB substrates, on heat sinks. In the simplest case, this may then take place together with an adhesion process for the signal electronics.

In particular for the adhesion process of the substrate, there is the problem that such a ceramic substrate may have thick Cu or Al strips or coatings on both sides, which together with the ceramic and the soldered-on power semiconductor chips, exhibits a bimetallic effect, unless they are symmetrically present on both sides.

The bimetallic effect is based on the different coefficients of thermal expansion of the metals in relation to silicone ceramic. The asymmetry is produced by the loading with chips on the circuit side and a circuit layout. The layout is characterized by trenches, in which the copper has been etched away to isolate different potentials. Consequently, even at room temperature, such substrates already have a complex warpage, corresponding to the structures. In the case of surface-area adhesion, this may lead to an inhomogeneous adhesive layer or voids in the adhesion.

These effects occur to a particularly high degree if the adhesion has to be cured at high temperatures, because the increase in temperature then causes other warpages. The adhesive layer generally does not adapt itself to these changes, as a result of which voids may again be produced. Inhomogeneous adhesive layers lead very quickly to deficient heat dissipation in the case of power semiconductors.

Adhesive bonds have previously not been used, in particular in the case of power semiconductor modules, because the deficient heat dissipation was not accepted. In the case of signal electronics and circuits of low power density, the increased heat resistances were accepted.

According to the invention, the substrates and the carrier plates or heat sinks are heated, for example before placement in the adhesive layer, to a temperature at which the substrate is planar. At this temperature, the adhesive bond is then also cured.

Since, after placing on the substrates, the arrangement no longer undergoes any temperature change, the shape and planarity are preserved. After curing of the adhesive, the adhesive thicknesses produced in this way are retained. Optionally, the carrier plates or heat sinks are then preheated.

The invention is therefore based, inter alia, on the forming of an adhesively bonded construction of carrier plates and substrates with power semiconductors which is distinguished by thin and approximately homogeneous adhesive layers. This aim is achieved by preheating substrates and/or carrier plates (base plates, heat sinks), so that the substrates have best possible conformation, and in particular planarity, from the outset or during the adhesion.

### Exemplary Embodiments

a. Since the loaded substrates have a low thermal mass, there is also the possibility of preheating only the carrier plate, applying the adhesive by screen printing, dispensing, stamping etc. quickly (in a short time compared with the curing time at this temperature) and then pressing the substrates, which are at room temperature, into the adhesive, whereby the substrate at a suitable temperature takes on a planar form and is securely held and pressed by the loading tool until after heating. After that, the planarity is retained again until the curing.

b. The substrate is not metallized on the rear side, which is adhesively attached. Consequently, there the substrate retains a ceramic surface (Al2O3, AlN, Si3N4 or similar ceramics). On account of the preceding soldering processes for the chips, this substrate is convexly bent at room temperature. By preheating the substrates and the carrier plate, or just by preheating the carrier plate, a planarity of the adhesive layers is achieved here. Ceramics with a content of rare-earth atoms, such as Zr for example, are used here with preference. This increases the fracture strength of the ceramic, which is particularly important in the case of one-sided metallization.

c. In one embodiment, if the substrates in complex form are placed in the just applied adhesive and then pressed from the middle outward, the heating and the stable planar state are achieved. Voids are avoided particularly well by this rolling out from the inside.

d. Even in the case of a two-sided coating with copper, rolling out as under c. is possible by preheating the substrates to a higher temperature, at which the substrate is convex, and preheating the carrier to a temperature at which the substrate is planar.

e. The preheating temperatures typically lie between 70° C. and 125° C. However, they depend somewhat on the layout structure and the pretreatment.

f. Thermally conducting, filled silicone adhesives, epoxy resin adhesives, thermoplastic adhesives, polyester adhesives or the like are used as adhesives. These are applied as a paste, liquid or film. The adhesives are in this case chosen such that the preheated adhesive layers still retain their deformability and wetting capability during the use of the substrates. The heat conduction of the adhesives is to be at least 0.5 W/mK. Materials with >5 W/mK are preferred.

g. Adhesives which become liquid under temperature and pressure and already become solid again after removal of the pressing pressure for the substrate are also preferred.

h. In the case of rapidly curing adhesives, the adhesive is applied with preference to the substrate underside when the substrate is not preheated. Consequently, the adhesive is kept at the curing temperature for less time before loading with components.

i. With the technology of adhesion, the substrates may also be applied directly to heat sinks of aluminum, carrier plates of aluminum and also base plates of AlSiC, other MMC (metal-matrix composite) carriers and copper (including metal-plated copper).

j. Alternatively, the carrier plate is formed by a liquid-cooled plate, which allows direct heat removal into an oil or water circuit or the like.

k. The carrier plate may also be formed by a three-dimensionally shaped body, which is for example also liquid-cooled, and the substrates are adhesively attached by the method described on various surfaces of the body.

l. With this method, the adhesive layer is set with preference to <70 μm.

m. These construction techniques and methods are combined for example with control electronics (low-level signal electronics) on the same carrier plate. The signal electronics are located either on ceramic substrates (thick, thin film) or printed circuit boards, which have likewise been adhesively attached.

To explain: the substrates of this type come from a soldering process or some other thermal connection process with temperatures of typically 250° C. or even higher. With such a strong increase in temperature, the copper has been plastically deformed. During the cooling, the substrate is transformed from the most convex state to planar and, at room temperature, concave, because the underside is completely covered with Cu and the upper side is discontinuous and Cu has the greater expansion in comparison with ceramic. If there is no Cu on the underside, a maximum concave state is achieved at soldering temperature and the maximum convex state at room temperature. In both end phases, the Cu is plastically deformed. Therefore, in multiple cycles, a hysteresis with a level of about 100° C. is obtained.

Structurally and/or functionally similar or comparable elements and components are designated below by the same reference numerals, without a detailed description being repeated each time they occur.

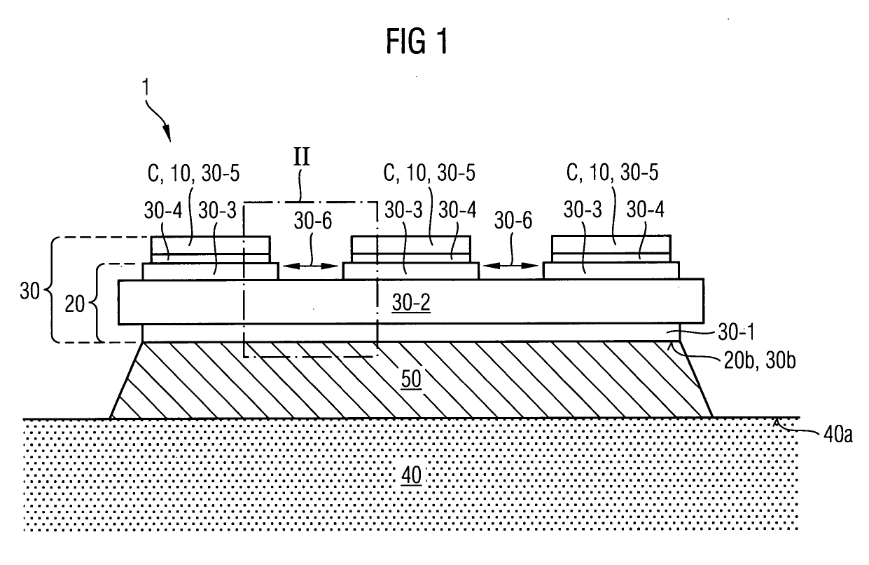

FIG. 1 illustrates a circuit module 1 which has been formed according to the invention in a schematic and sectioned side view.

The circuit module 1 according to FIG. 1 includes a carrier 40 with a surface region 40a or an upper side 40a. Formed above the surface 40a or upper side 40a of the carrier 40 is a semiconductor substrate 30 with an underside 30b.

The semiconductor substrate 30 is formed by a lowermost metal layer 30-1, for example of copper or aluminum, which is adjoined by a ceramic layer 30-2. Formed on the surface of the ceramic layer 30-2 are metallic regions 30-3, likewise of copper or aluminum, on which the actual semiconductor components 30-5 or chips 30-5, which provide and comprise the actual semiconductor circuit 10, are arranged by means of a solder 30-4 or LTC (low-temperature connecting method with silver paste).

The layer 30-1 of copper or aluminum, the ceramic 30-2 and the uppermost regions 30-3, likewise of copper or aluminum, form the actual substrate 20, which forms the basis for the semiconductor substrate 30 and the underside 20b of which coincides with the underside 30b of the semiconductor substrate 30.

For attaching and fixing the semiconductor substrate 30 by the underside 30b on the upper side 40a of the carrier 40, an adhesive 50 is formed.

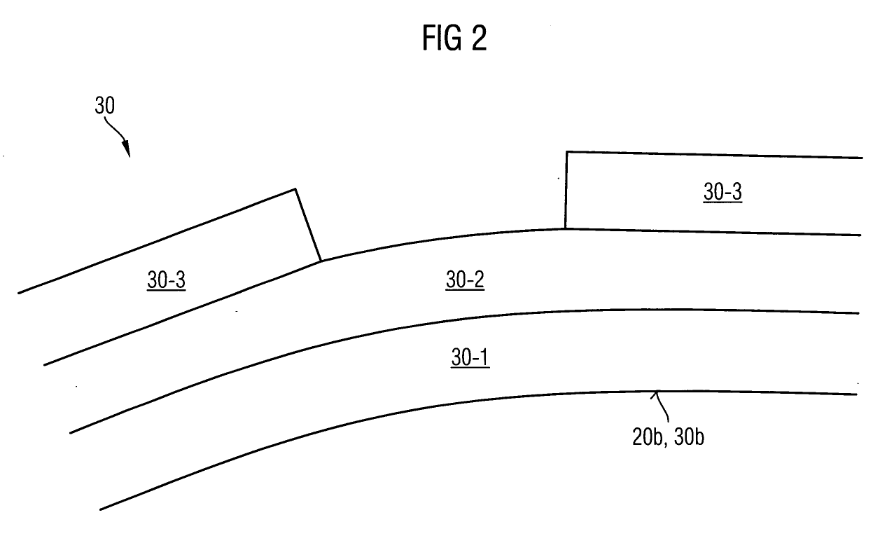

FIG. 2 illustrates in greater detail particulars of the situation represented in FIG. 1 in the region II. Intermediate regions in the form of trenches 30-6 can be seen there between the upper metallizations 30-3 of copper or aluminum on the ceramic 30-2. The trenches 30-6 or recesses 30-6 serve for the electrical isolation. On account of the sequence of the various layers 30-1, 30-2, 30-3 of metal, ceramic and again metal, different mechanical stresses can occur in the region of the semiconductor substrate 30 under alternating thermal load, that is to say changing thermal conditions, so that the quality of the attachment and fixing, and ultimately of the contact between the semiconductor substrate 30 and the carrier 40, under some circumstances depends strongly on the thermal situation in which the attachment and fixing takes place, in particular in the region of the recesses 30-6 or trenches 30-6.

In FIG. 2 it is illustrated that, on account of the thermal conditions and the differences in the expansions of the different materials accompanying the thermal conditions, curvatures and warpages can occur in the region of the semiconductor substrate 30, reminiscent of a bimetallic effect and largely caused by the asymmetry of the layer formation.

If such a curved semiconductor substrate 30 is applied to the surface 40a, in turn by means of the adhesive 50, the adhering structure may not be able to make allowance for the mechanical irregularities or withstand their changes brought by changes in the thermal conditions. This problem is reduced or avoided by the invention.

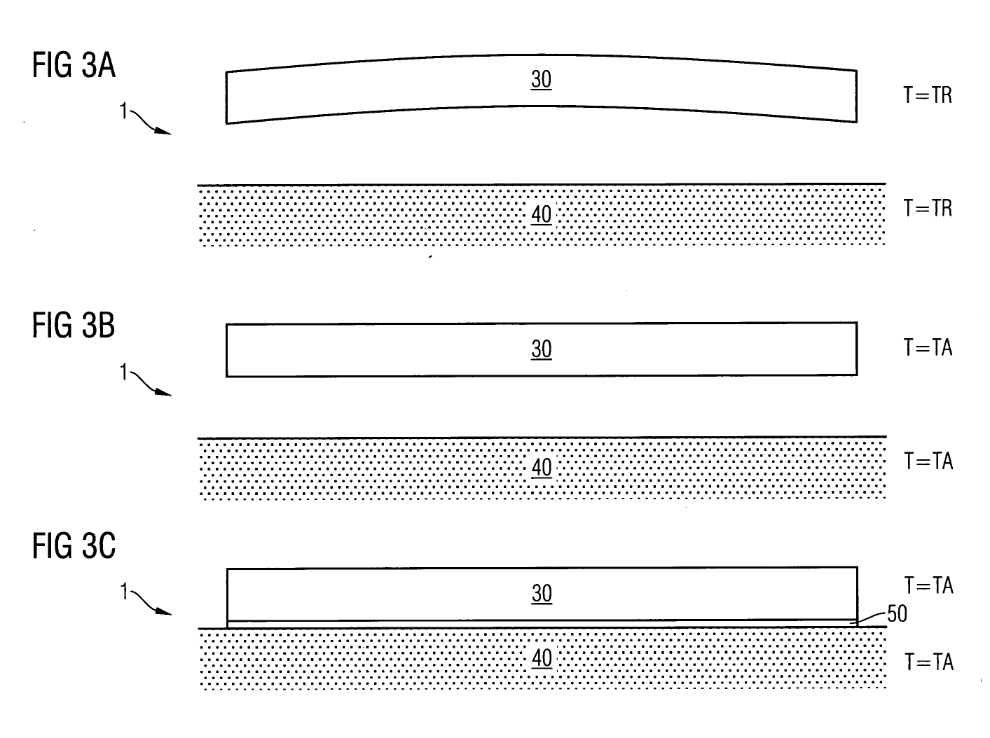

FIGS. 3A to 3C illustrate a first embodiment of the method according to the invention for producing circuit modules 1.

In FIG. 3A, the carrier 40 and the semiconductor substrate 30 are represented in a schematic manner and spatially at a distance from each other. The carrier 40 and the semiconductor substrate 30 are at room temperature TR. The semiconductor substrate 30 is concavely curved, at least on the underside 30b.

In the transition to the intermediate state illustrated in FIG. 3B, the so-called curing temperature TA is set and maintained for the carrier 40 and the semiconductor substrate 30. This curing temperature TA is chosen such that the concave curvature on the underside 20b, 30b of the substrate 20 or of the semiconductor substrate 30 is partially or completely compensated, so that, according to the embodiment of FIGS. 3A to 3C, a planar underside 20b, 30b is obtained for the substrate 20 and for the semiconductor substrate 30, respectively.

In the transition to the intermediate state illustrated in FIG. 3C, while providing an adhesive 50, the semiconductor substrate 30, here in planar form at the curing temperature TA, is then applied by its underside 30b to the upper side 40a of the carrier 40 with the adhesive 50 in between and is pressed on by means of pressure.

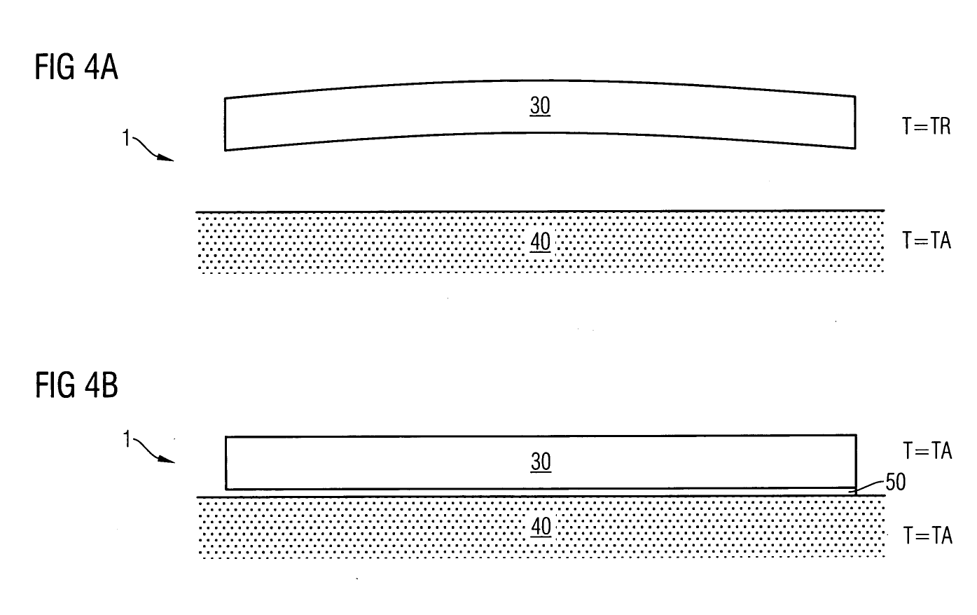

The embodiment according to FIGS. 4A and 4B illustrates a somewhat simplified method sequence. The state which is represented in FIG. 4A corresponds to the state of FIG. 3A. The semiconductor substrate 30 and the carrier 40 are opposite each other, spatially at a distance, and are at room temperature TR or already at the curing temperature TA.

In the transition to the intermediate state illustrated in FIG. 4B, while providing an adhesive 50, the semiconductor substrate 30, at room temperature TR, is applied by its underside 30b directly and without any change in temperature to the upper side 40a of the carrier 40, which is at the curing temperature TA. The carrier 40 is either kept at the curing temperature TA by a heat bath or else its thermal capacity is significantly greater than that of the semiconductor substrate 30, so that the heat transfer between the carrier and the semiconductor substrate 30 leads to the formation of a thermodynamic equilibrium between the semiconductor substrate 30 and the carrier 40, but not to any appreciable change in temperature of the carrier 40, and consequently of the overall system including the carrier 40 and the semiconductor substrate 30.

According to this procedure last described, it is firstly possible to dispense with the intermediate process of changing the temperature.

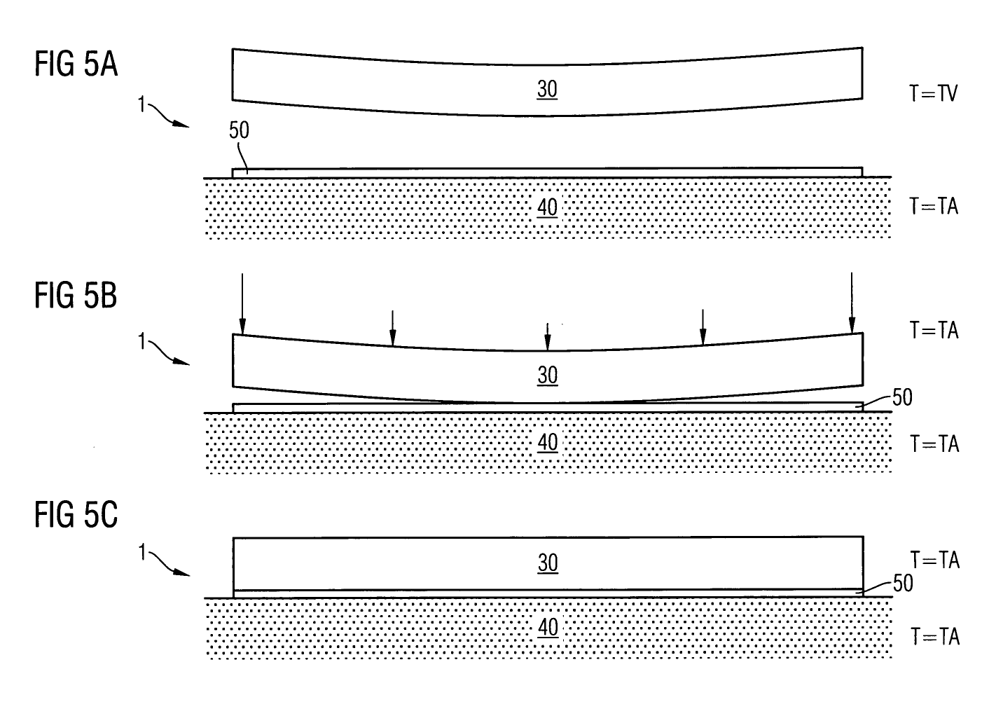

In the embodiment of FIGS. 5A to 5C, according to the first intermediate state, which is illustrated in FIG. 5A, the semiconductor substrate 30 is set at a preliminary temperature TV, at which the underside 30b of the semiconductor substrate 30 exhibits a convex warpage in comparison with the upper side 40a of the carrier 40.

In the transition to the intermediate states illustrated in FIGS. 5B and 5C, while providing an adhesive 50, the semiconductor substrate 30 is then pressed by the convexly warped underside 30b onto the upper side 40a of the carrier 40, which is planar, preferably with a pressure proceeding from the central region of the semiconductor substrate 30 toward the edge. The semiconductor substrate 30 is virtually rolled out on the surface or upper side 40a of the carrier 40.

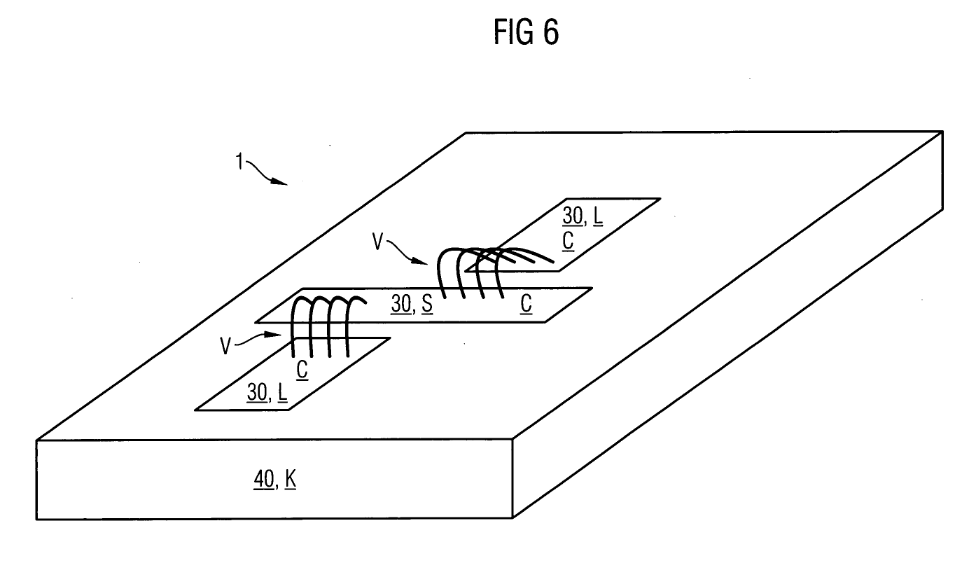

FIG. 6 illustrates in a perspective side view a circuit module 1 produced according to the invention, in which a plurality of different semiconductor substrates 30 are applied on a heat sink K serving as the carrier 40. These are on the one hand power semiconductor substrates L and on the other hand on substrates S for signal electronics. The substrates 30 are connected by means of corresponding electrical connections, for example in the form of so-called bonding wires.

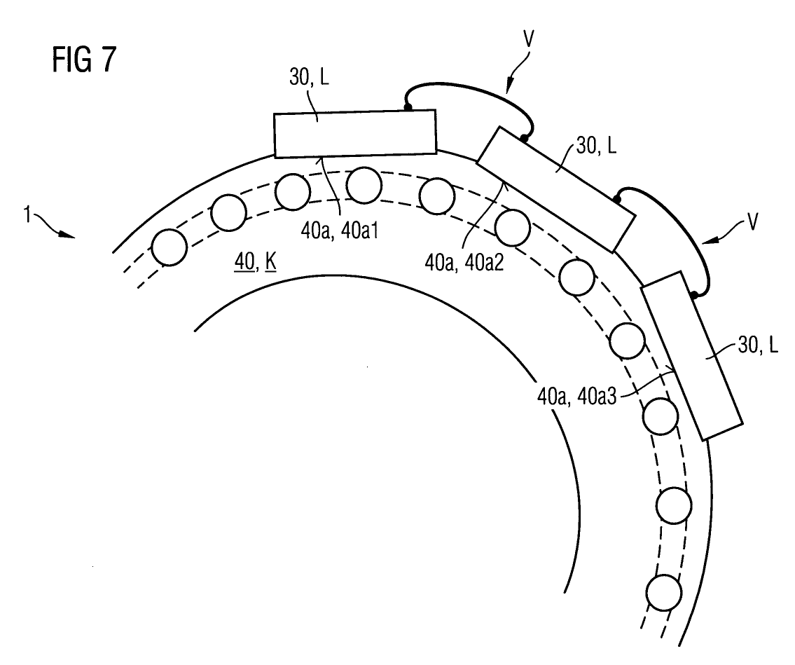

FIG. 7 explains that the carrier 40, here again in the form of a heat sink, which here can be flowed through by a coolant on account of the channels provided, may have on its surface 40a differently shaped, arranged and/or inclined surface portions 40a1, 40a2, 40a3, which may in each case be loaded with corresponding semiconductor substrates 30. Here, too, corresponding electrical connections, for example in the form of bonding wires, are again provided.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for producing a circuit module, comprising:
providing at least one semiconductor substrate having a semiconductor circuit on a substrate with an underside;
providing at least one carrier having an upper side or surface;
attaching and fixing the semiconductor substrate by the underside of the substrate or the semiconductor substrate on the upper side or surface of the carrier by adhesion using an adhesive;
curing the adhesive during the adhesion;
in which at least the semiconductor substrate is brought to and kept at a curing temperature during the curing; and
wherein the curing temperature is chosen and set in such a way that the underside of the substrate or the semiconductor substrate corresponds completely or substantially in a conformal manner to the upper side or surface of the carrier.

2. The method as claimed in claim 1, wherein with a planar or approximately planar upper side or surface of the carrier, the curing temperature is set and maintained in such a way that the underside of the substrate is planar or approximately planar.

3. The method as claimed in claim 1, comprising setting the curing temperature such that thermal stresses on account of different thermal expansion properties in the semiconductor substrate form and, in particular, compensate one another to create a desired shape of the underside of the substrate.

4. The method as claimed in claim 1, comprising using a substrate from the group formed by substrates with a number of different materials, substrates of a layered construction, DCB substrates, AMB substrates and ceramic-based substrates with metallic regions or components as the substrate or as the semiconductor substrate.

5. The method as claimed in claim 1, comprising setting the curing temperature and maintaining by heating the substrate, the semiconductor substrate and/or the adhesive.

6. The method as claimed in claim 1, comprising setting the curing temperature and maintaining by cooling the substrate, the semiconductor substrate and/or the adhesive.

7. The method as claimed in claim 1, in which at least the semiconductor substrate, also the carrier and/or the adhesive, are kept constantly or approximately constantly at the curing temperature during the curing of the adhesive and in which, as a result, the layer thickness of the adhesive between the semiconductor substrate and the carrier is kept constant over time or approximately constant over time, in particular with the same or approximately the same layer thickness.

8. The method as claimed in claim 1, in which the semiconductor substrate, the carrier and/or the adhesive are jointly brought to the curing temperature and kept there, in particular by means of a heat bath.

9. The method as claimed in claim 1, in which the semiconductor substrate and/or the adhesive are brought to the curing temperature and/or kept there, in that they are directly or indirectly thermally coupled with the carrier and in that the carrier is brought to the curing temperature and kept there, in particular by means of a heat bath.

10. The method as claimed in claim 1, in which a semiconductor substrate and/or an adhesive with a low thermal capacity in comparison with the carrier are used.

11. The method as claimed in claim 1, in which an adhesive with a comparatively high thermal conductivity is used.

12. The method as claimed in claim 1, in which the semiconductor substrate, the carrier and/or the adhesive are brought to the curing temperature and kept there before the adhesive is applied to the underside of the substrate or the semiconductor substrate and/or to the upper side of the carrier.

13. The method as claimed in claim 1, in which the semiconductor substrate and the carrier with the adhesive in between are brought against one another by application of pressure and fixed, so that the semiconductor substrate is thereby pressed into the adhesive.

14. The method as claimed in claim 1, in which the adhesive on the underside of the substrate or the semiconductor substrate and/or on the upper side of the carrier is applied such that it is planar or conformal or in certain portions is planar or conformal.

15. The method as claimed in claim 1, in which the adhesive is applied by screen printing, dispensing or stamping.

16. A method for producing a circuit module, comprising:
providing at least one semiconductor substrate having a semiconductor circuit on a substrate with an underside;
providing at least one carrier having an upper side or surface;
attaching and fixing the semiconductor substrate by the underside of the substrate or the semiconductor substrate on the upper side or surface of the carrier by adhesion using an adhesive;
curing the adhesive during the adhesion;
in which at least the semiconductor substrate is brought to and kept at a curing temperature during the curing; and
wherein the curing temperature is chosen and set in such a way that the underside of the substrate or the semiconductor substrate corresponds completely or substantially in a conformal manner to the upper side or surface of the carrier; and
wherein the semiconductor substrate is first brought to a preliminary temperature, at which the underside of the substrate or the semiconductor substrate is formed convexly or locally convexly in relation to the upper side of the carrier, in which then the semiconductor substrate is applied by the underside of the substrate or the semiconductor substrate to the upper side of the carrier with the adhesive in between, and in which then the curing temperature is set and maintained.

17. The method as claimed in claim 16, in which the semiconductor substrate is pressed against the carrier or rolled out on it by pressure from the inside outward with respect to the contact area.

18. The method as claimed in claim 16, in which an adhesive is used from the group comprising thermally conducting adhesives, filled silicone adhesives, epoxy resin adhesives, thermoplastic adhesives, polyester adhesives, adhesives in paste form, liquid adhesives, adhesives in the form of films, adhesives with a thermal conduction in the range of at least 0.5 W/mK, adhesives with a thermal conductivity in the range of more than 5 W/mK and adhesives which become liquid under temperature and/or pressure and solidify when a pressure is removed or they are relieved of stress.

19. The method as claimed in claim 16, in which carriers are used from the group comprising heat sinks, carrier plates, base plates, carriers of aluminum, carriers of AlSiC, MMC carriers, metal-matrix composite carriers, carriers of copper, nickel-plated carriers, liquid-cooled carriers or heat sinks, gas-cooled carriers or heat sinks and three-dimensionally shaped bodies.

20. The method as claimed in claim 16, in which semiconductor substrates are used from the group comprising power semiconductor substrates, signal-electronics semiconductor substrates and semiconductor substrates based on thin-film or thick-film ceramics.

21. The method as claimed in claim 16, in which a number of semiconductor substrates are attached on one or more portions of the surface of one or more carriers.

22. The method as claimed in claim 16, in which an adhesive with a layer thickness of below 70 μm is used.

23. A method for mounting a power semiconductor module, comprising a power semiconductor and a DCB or AMB substrate soldered to it, onto the carrier, comprising:
providing at least one power semiconductor module comprising a power semiconductor and a DCB or AMB substrate soldered to it, which has an underside;
providing at least one carrier having an upper side;
attaching and fixing the power semiconductor module by the underside of the DCB or AMB substrate on the upper side of the carrier; and
wherein the attachment of the power semiconductor module on the carrier takes place by adhesion using an adhesive curing at a curing temperature.

24. A method for producing a circuit module, comprising:
providing at least one semiconductor substrate having a semiconductor circuit on a substrate with an underside;
providing at least one carrier having an upper side or surface;
attaching and fixing the semiconductor substrate by the underside of the substrate or the semiconductor substrate on the upper side or surface of the carrier by adhesion using means for adhesion;
curing the means for adhesion during the adhesion;
in which at least the semiconductor substrate is brought to and kept at a curing temperature during the curing; and
in which the curing temperature is chosen and set in such a way that the underside of the substrate or the semiconductor substrate corresponds completely or substantially in a conformal manner to the upper side or surface of the carrier.
